(19) United States
(12) Patent Application Publication
(10) Pub. No.: US 2025/0246128 A1
(43) Pub. Date: Jul. 31, 2025

(54) LIGHT EMITTING DEVICE, DISPLAY DEVICE, PHOTOELECTRIC CONVERSION DEVICE, ELECTRONIC APPARATUS, ILLUMINATION DEVICE, AND MOVING BODY

(71) Applicant: CANON KABUSHIKI KAISHA, Tokyo (JP)

(72) Inventor: TARO MURAKI, Kanagawa (JP)

(21) Appl. No.: 19/019,758

(22) Filed: Jan. 14, 2025

(30) Foreign Application Priority Data
Jan. 26, 2024 (JP) 2024-010290

(51) Int. Cl. G09G 3/32; H04N 23/63

(52) U.S. Cl. CPC G09G 3/32; H04N 23/63; G09G 2300/0426; G09G 2310/08

(57) ABSTRACT

A light emitting device includes pixel circuits, a driving circuit configured to select, from the pixel circuits, a pixel circuit to write the pixel signal, and power supply lines configured to supply power supply voltages to the plurality of pixel circuits. The power supply lines include a power supply line extending in a first direction in a portion overlapping a part of the plurality of pixel circuits. A number of pixel circuits to be selected by the driving circuit at a first timing from two or more pixel circuits arranged along the first direction is not more than two. A number of pixel circuits to be selected by the driving circuit at a second timing from two or more pixel circuits arranged along a second direction orthogonal to the first direction is not more than two.

### BACKGROUND OF THE INVENTION

### Field of the Invention

The present invention relates to a light emitting device, a display device, a photoelectric conversion device, an electronic apparatus, an illumination device, and a moving body.

### Description of the Related Art

Japanese Patent Laid-Open No. 2007-024994 describes a display device in which a light detection element is provided in the vicinity of each light emitting element arranged in a display surface to correct the brightness of the light emitting element while an image is being displayed. If a pixel signal having a large value is written in a pixel circuit, the power supply voltage supplied to other pixel circuits around this pixel circuit can largely drop. Due to this voltage drop, the value of the pixel signal written in the surrounding pixel circuit may change, and light with the intended brightness may not be emitted.

### SUMMARY OF THE INVENTION

An aspect of the present invention provides a technique for reducing the influence of a voltage drop on light emission.

According to some embodiments, a light emitting device is provided. The device includes a plurality of pixel circuits each including a light emitting element configured to emit light with a brightness corresponding to a pixel signal, a driving circuit configured to select, from the plurality of pixel circuits, a pixel circuit to write the pixel signal, and a plurality of power supply lines configured to supply power supply voltages to the plurality of pixel circuits. The plurality of power supply lines include a power supply line extending in a first direction in a portion overlapping a part of the plurality of pixel circuits. A number of pixel circuits to be selected by the driving circuit at a first timing from two or more pixel circuits, of the plurality of pixel circuits, arranged along the first direction is not more than two. A number of pixel circuits to be selected by the driving circuit at a second timing from two or more pixel circuits, of the plurality of pixel circuits, arranged along a second direction orthogonal to the first direction is not more than two.

Further features of the present invention will become apparent from the following description of exemplary embodiments with reference to the attached drawings.

### BRIEF DESCRIPTION OF THE DRAWINGS

FIG. 1 is a block diagram for explaining an example of the arrangement of a light emitting device according to some embodiments;

FIG. 2 is an equivalent circuit diagram for explaining an example of the arrangement of a pixel circuit according to some embodiments;

FIG. 3 is an equivalent circuit diagram for explaining an example of the arrangement of a light emitting circuit according to some embodiments;

FIG. 4 is a layout diagram for explaining an example of the arrangement of power supply lines according to some embodiments;

FIGS. 5A to 5C are schematic views each for explaining an operation example of the light emitting circuit according to some embodiments;

FIG. 6 is an equivalent circuit diagram for explaining a modification of the light emitting circuit according to some embodiments;

FIGS. 7A and 7B are views for explaining a modification of the light emitting device according to some embodiments;

FIGS. 8A and 8B are sectional views showing an example of the arrangement of a pixel circuit according to some embodiments;

FIGS. 9A to 9C are views showing an example of an image forming device using the light emitting device according to some embodiments;

FIG. 10 is a view showing an example of a display device using the light emitting device according to some embodiments;

FIG. 11 is a view showing an example of a photoelectric conversion device using the light emitting device according to some embodiments;

FIG. 12 is a view showing an example of an electronic apparatus using the light emitting device according to some embodiments;

FIGS. 13A and 13B are views each showing an example of a display device using the light emitting device according to some embodiments;

FIG. 14 is a view showing an example of an illumination device using the light emitting device according to some embodiments;

FIG. 15 is a view showing an example of a moving body using the light emitting device according to some embodiments; and

FIGS. 16A and 16B are views each showing an example of a wearable device using the light emitting device according to some embodiments.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

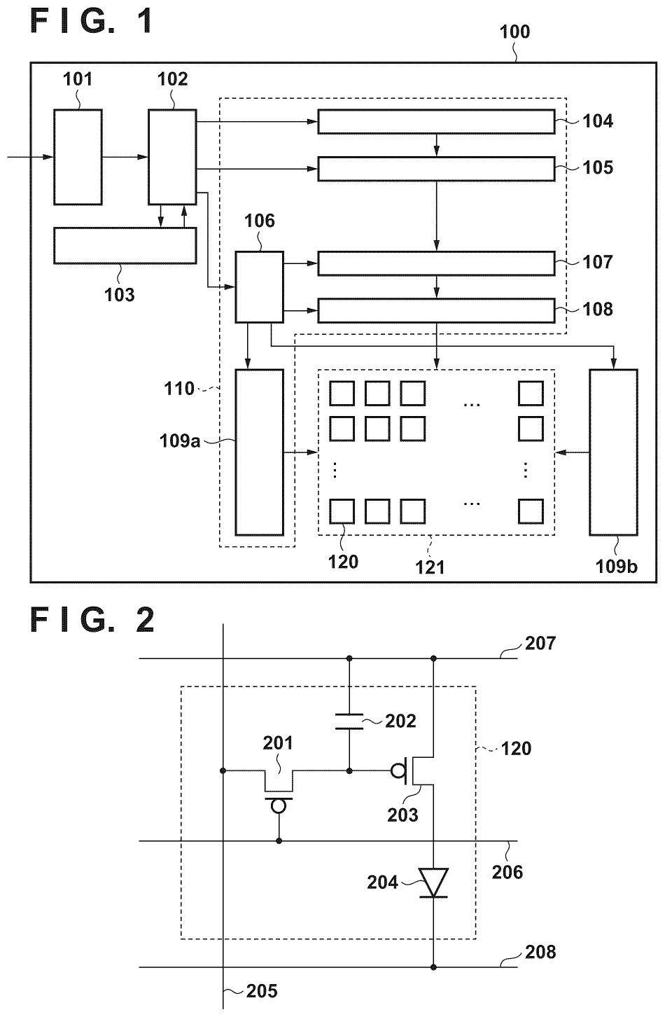

With reference to FIGS. 1 to 7B, a light emitting device 100 according to some embodiments will be described. The embodiments to be explained below are merely examples of the present disclosure. The numerical values, shapes, materials, the arrangement of the components, and the like in the following description do not intend to limit the present disclosure.

With reference to a block diagram of FIG. 1, an example of the arrangement of the light emitting device 100 will be described. The light emitting device 100 may be used to display a desired image or the like. The light emitting device 100 can include a plurality of pixel circuits 120, a driving circuit 110, and a signal processing circuit 102. The light emitting device 100 can further include a receiving circuit 101 and a memory 103. The light emitting device 100 may not include some of the components shown in FIG. 1, or may include components not shown in FIG. 1.

The plurality of pixel circuits 120 are arranged in a pixel region 121 to form a two-dimensional array. In FIG. 1, only one of the plurality of pixel circuits 120 is given a reference numeral. In the following description, a set of two or more pixel circuits 120 arranged in the horizontal direction in FIG. 1 is referred to as a pixel row, and a set of two or more pixel circuits 120 arranged in the vertical direction in FIG. 1 is referred to as a pixel column. The plurality of pixel circuits 120 are arranged to form a plurality of pixel rows and a plurality of pixel columns. Each of the plurality of pixel circuits 120 emits light with a brightness corresponding to the supplied pixel signal. The pixel signal can take a value representing the brightness of light to be emitted by the pixel circuit 120. In the following description, the value taken by the pixel signal is sometimes referred to as a signal value.

The driving circuit 110 writes the pixel signal in each of the plurality of pixel circuits 120. As shown in FIG. 1, the driving circuit 110 can include a column selection circuit 104, a column memory 105, a timing signal generator 106, a column digital-analog converter (DAC) 107, a column buffer 108, and row selection circuits 109a and 109b.

The receiving circuit 101 receives display data supplied from the outside of the light emitting device 100 for display on the pixel region 121. The display data received by the receiving circuit 101 is supplied to the signal processing circuit 102. The memory 103 is connected to the signal processing circuit 102. The memory 103 is a memory area for temporarily storing the display data supplied from the outside.

After display data for one frame are stored in the memory 103, the signal processing circuit 102 processes the display data for display on the pixel region 121. For example, the signal processing circuit 102 sorts the display data in the order of light emission, thereby generating column driving data and signal value data. The signal processing circuit 102 transfers the column driving data to the column selection circuit 104, and transfers the signal value data to the column memory 105. Each of the column driving data and signal value data can be data for each pixel row in the pixel region 121 including the plurality of pixel circuits 120. The signal processing circuit 102 also transmits a timing control signal for controlling the operation timing in the driving circuit 110 to the timing signal generator 106.

Based on the supplied column driving data, the column selection circuit 104 generates a selection signal for selecting the pixel circuit 120 in a predetermined column for each pixel row. The column selection circuit 104 also causes the column memory 105 to supply, to the column DAC 107, the data (to be sometimes referred to as column data hereinafter) of the signal value corresponding to each pixel circuit 120 in the selected column among the signal value data supplied to the column memory 105. In the following description, all the signal value data supplied to the column memory 105 are supplied to the column DAC 107 for each pixel row. Instead, some data may be selected from the signal value data supplied to the column memory 105, and supplied to the column DAC 107.

In accordance with a timing signal input from the timing signal generator 106, the column DAC 107 DA-converts the signal value of the column data supplied from the column memory 105. The pixel signal representing the signal value of the column data converted from a digital value to an analog value by the column DAC 107 is supplied to the pixel region 121 via the column buffer 108. The timing signal generator 106 supplies the timing signal to the row selection circuits 109a and 109b. The row selection circuits 109a and 109b select, from the plurality of pixel circuits 120, the pixel circuit 120 to write the pixel signal. In accordance with the supplied timing signal, the row selection circuits 109a and 109b generate a selection signal synchronized with the column data, and supply the selection signal to the pixel circuit 120 selected from the plurality of pixel circuits 120. The signal value of the pixel signal is written in the pixel circuit 120 selected from the plurality of pixel circuits 120 by the row selection circuits 109a and 109b. The pixel circuit 120 emits light with the brightness corresponding to the written signal value.

With reference to an equivalent circuit diagram of FIG. 2, an example of the arrangement of the pixel circuit 120 will be described. All of the plurality of pixel circuits 120 included in the light emitting device 100 may have the arrangement shown in FIG. 2. The pixel circuit 120 includes a write transistor 201, a holding capacitor 202, a driving transistor 203, and a light emitting element 204. In FIG. 2, the write transistor 201 and the driving transistor 203 are shown as p-channel transistors. Instead, at least one of these transistors may be an n-channel transistor, or a suitable configuration other than the transistor may be used.

The write transistor 201 is a transistor for controlling writing of a pixel signal in the pixel circuit 120 (more specifically, the holding capacitor 202). One main terminal (the drain in the example shown in FIG. 2) of the write transistor 201 is connected to a signal line 205. The other main terminal (the source in the example shown in FIG. 2) of the write transistor 201 is connected to one terminal of the holding capacitor 202 and the gate of the driving transistor 203. The gate of the write transistor 201 is connected to a scanning line 206.

The holding capacitor 202 holds the pixel signal written in the pixel circuit 120. One terminal of the holding capacitor 202 is connected to one main terminal of the write transistor 201 and the gate of the driving transistor 203. The other terminal of the holding capacitor 202 is connected to a power supply line 207. The power supply line 207 is supplied with a power supply voltage (for example, VDD).

The driving transistor 203 supplies a current corresponding to the value (that is, signal value) of the pixel signal to the light emitting element 204. One main terminal (the source in the example shown in FIG. 2) of the driving transistor 203 is connected to one electrode (the anode in the example shown in FIG. 2) of the light emitting element 204. The other main terminal (the drain in the example shown in FIG. 2) of the driving transistor 203 is connected to the power supply line 207. Another circuit element may or may not be arranged in the signal path between the driving transistor 203 and the light emitting element 204. Another circuit element may or may not be arranged in the signal path between the driving transistor 203 and the power supply line 207.

One electrode (the anode in the example shown in FIG. 2) of the light emitting element 204 is connected to one main terminal of the driving transistor 203. The other electrode (the cathode in the example shown in FIG. 2) of the light emitting element 204 is connected to a ground line 208. The ground line 208 is supplied with a ground voltage.

The signal line 205 is supplied with a pixel signal from the driving circuit 110 (more specifically, the column buffer 108). When a selection signal is supplied to the scanning line 206, the write transistor 201 is turned on. In accordance with this, the pixel signal supplied to the signal line 205 is written in the holding capacitor 202. As a result, the light emitting element 204 emits light with the brightness corresponding to the pixel signal held by the holding capacitor 202. The pixel signal written in the holding capacitor 202 continues to be held in the holding capacitor 202 even after the write transistor 201 is turned off. In this manner, the selection signal is a signal for writing the pixel signal in the pixel circuit 120 (more specifically, the holding capacitor 202).

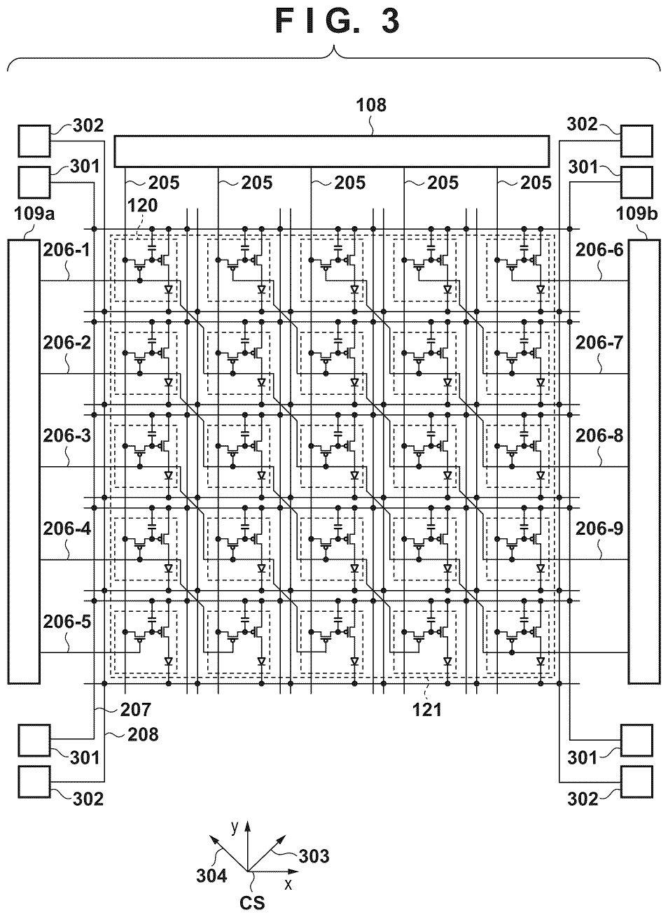

With reference to an equivalent circuit diagram of FIG. 3, an example of the arrangement of the signal line 205, the scanning line 206, the power supply line 207, and the ground line 208 will be described. In order to explain directions, a coordinate system CS formed from an x-axis and a y-axis orthogonal to each other is given in FIG. 3 and subsequent drawings. The x-axis of the coordinate system CS is simply referred to as the x-axis, and the y-axis of the coordinate system CS is simply referred to as the y-axis. A direction that forms an angle of 45° with each of the x-axis and the y-axis is referred to as a direction 303. A direction orthogonal to the direction 303 is referred to as a direction 304.

The extending direction of each of the plurality of pixel rows is parallel to the x-axis direction, is orthogonal to the y-axis direction, obliquely intersects the direction 303, and obliquely intersects the direction 304. The extending direction of one pixel row may be a direction along which two or more pixel circuits 120 included in this pixel row are arranged. The extending direction of each of the plurality of pixel columns is parallel to the y-axis direction, is orthogonal to the x-axis direction, obliquely intersects the direction 303, and obliquely intersects the direction 304. The extending direction of one pixel column may be a direction along which two or more pixel circuits 120 included in this pixel column are arranged. When two directions obliquely intersect, the angle formed by the two directions may be larger than 0° and smaller than 90°.

In the example shown in FIG. 3, 25 pixel circuits 120 are arranged in five rows×five columns. However, the number, the number of rows, and the number of columns of the pixel circuits 120 are not limited to these. The number of rows of the pixel circuits 120 may be an arbitrary number of two or more. The number of columns of the pixel circuits 120 may be an arbitrary number of two or more. The pixel circuits 120 may have the same or different numbers of rows and columns.

The light emitting device 100 includes a plurality of signal lines 205. Pixel signals are supplied to the plurality of pixel circuits 120 through the plurality of signal lines 205. Each of the plurality of signal lines 205 is parallel to the y-axis direction. The individual signal line 205 is arranged for each pixel column. The signal line 205 is connected to each of two or more pixel circuits 120 included in the corresponding pixel column. One end of the signal line 205 is connected to the column buffer 108.

The light emitting device 100 includes a plurality of scanning lines 206. Selection signals are supplied to the plurality of pixel circuits 120 through the plurality of scanning lines 206. In FIG. 3, to discriminate the plurality of scanning lines 206 from each other, a suffix is added thereto, like scanning lines 206-1 to 206-9. Each of the scanning lines 206-1 to 206-4 and 206-7 to 206-9 is connected to two or more pixel circuits 120 arranged along the direction 304 among the plurality of pixel circuits 120. For example, the scanning line 206-1 is connected to the pixel circuits 120 located in the ith row from the top and the ith column from the left (1≤i≤5). The scanning line 206-2 is connected to the pixel circuits 120 located in the (i+1)th row from the top and the ith column from the left (1≤i≤4). This also applies to other scanning lines 206. Each of the scanning lines 206-5 and 206-6 is connected to one pixel circuit 120. At least one of the plurality of scanning lines 206 (more specifically, the scanning lines 206-1 to 206-4 and 206-7 to 206-9) includes a portion obliquely intersecting both the x-axis direction and the y-axis direction. More specifically, each of these scanning lines 206 includes a portion extending along the direction 304.

One end of each of the scanning lines 206-1 to 206-5 is connected to the row selection circuit 109a. One end of each of the scanning lines 206-1 and 206-6 to 206-9 is connected to the row selection circuit 109b. In the example shown in FIG. 3, the scanning line 206-1 is connected to both the row selection circuit 109a and the row selection circuit 109b. Instead, the scanning line 206-1 may be connected to only one of the row selection circuit 109a and the row selection circuit 109b. In FIG. 3, each of the scanning lines 206-2 to 206-9 is connected to only one of the two row selection circuits 109a and 109b. Instead, each of the scanning lines 206-2 to 206-9 may be connected to both of the two row selection circuits 109a and 109b. Furthermore, all of the plurality of scanning lines 206-1 to 206-9 may be connected to one of the two row selection circuits 109a and 109b, and the other of the two row selection circuits 109a and 109b may be omitted.

The light emitting device 100 includes the power supply line 207. The power supply line 207 is used to supply a power supply voltage to the plurality of pixel circuits 120. The power supply line 207 is connected to each of four electrode pads 301 arranged at four corners of the light emitting device 100. The power supply voltage is supplied to the electrode pad 301 from the outside of the light emitting device 100. In the example shown in FIG. 3, the light emitting device 100 includes four electrode pads 301. Instead, the light emitting device 100 may include one or more electrode pads 301.

The light emitting device 100 includes the ground line 208. The ground line 208 is used to supply a ground voltage to the plurality of pixel circuits 120. The ground line 208 is connected to each of four electrode pads 302 arranged at four corners of the light emitting device 100. The ground voltage is supplied to the electrode pad 302 from the outside of the light emitting device 100. In the example shown in FIG. 3, the light emitting device 100 includes four electrode pads 302. Instead, the light emitting device 100 may include one or more electrode pads 302.

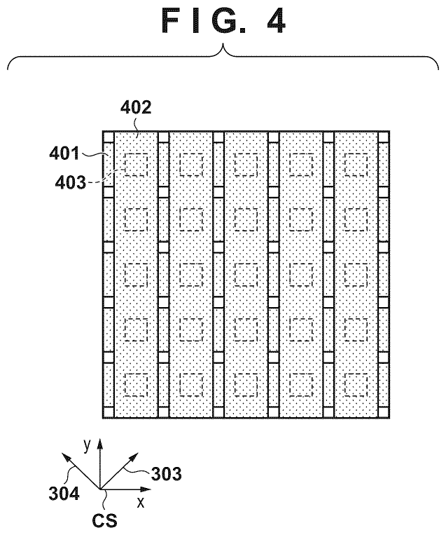

With reference to a layout diagram of FIG. 4, a specific example of the arrangement of the power supply line 207 will be described. The ground line 208 may have a layout similar to that of the power supply line 207. FIG. 4 shows the layout of the power supply line 207 at a position overlapping the pixel region 121.

In the example shown in FIG. 4, the power supply line 207 is formed by a plurality of power supply lines 401 and a plurality of power supply lines 402. The plurality of power supply lines 401 and the plurality of power supply lines 402 are connected to each other by a plurality of plugs 403. In FIG. 4, only one of the plurality of power supply lines 401, only one of the plurality of power supply lines 402, and only one of the plurality of plugs 403 are given reference numerals, respectively.

Each of the plurality of power supply lines 401 extends in the x-axis direction in the portion overlapping the plurality of pixel circuits 120. Each of the plurality of power supply lines 402 extends in the y-axis direction in the portion overlapping the plurality of pixel circuits 120. The plurality of power supply lines 401 are formed in one wiring layer, and the plurality of power supply lines 402 are formed in another wiring layer. Either one of the wiring layer where the plurality of power supply lines 401 are formed and the wiring layer where the plurality of power supply lines 402 are formed may be arranged on the lower side (that is, near the substrate). The plurality of power supply lines 401 may be connected to the electrode pad 301 through another power supply line arranged outside the pixel region 121. The plurality of power supply lines 402 may be connected to the electrode pad 301 through another power supply line arranged outside the pixel region 121.

One power supply line 401 may be connected to one pixel circuit 120 in each pixel column. Instead, one power supply line 401 may be connected to two or more pixel circuits 120 in each pixel column. This also applies to the power supply line 402.

In the example shown in FIG. 4, the plurality of power supply lines 401 and the plurality of power supply lines 402 form the grid power supply lines 207. Instead, either the plurality of power supply lines 401 or the plurality of power supply lines 402 may be omitted.

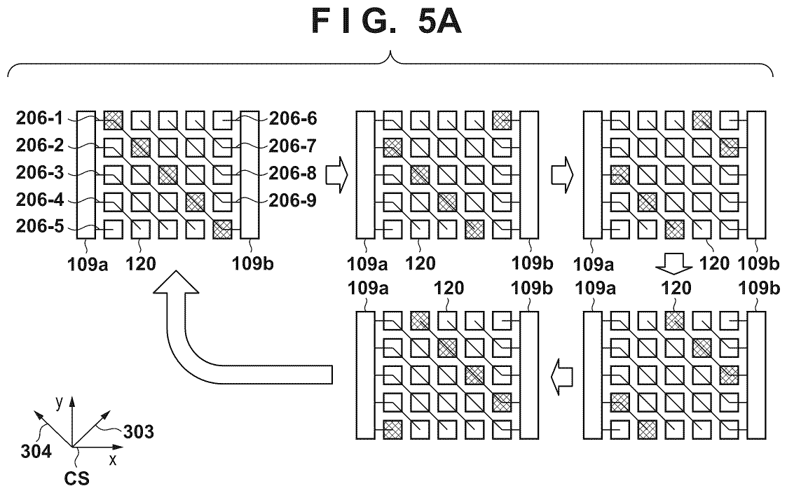

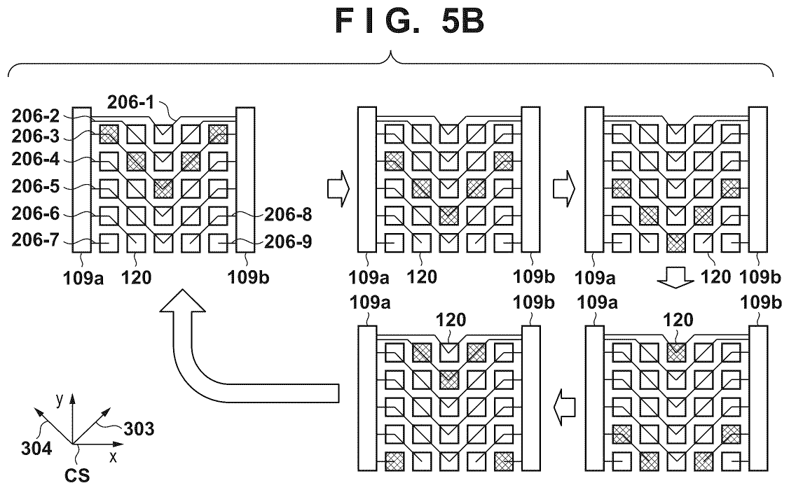

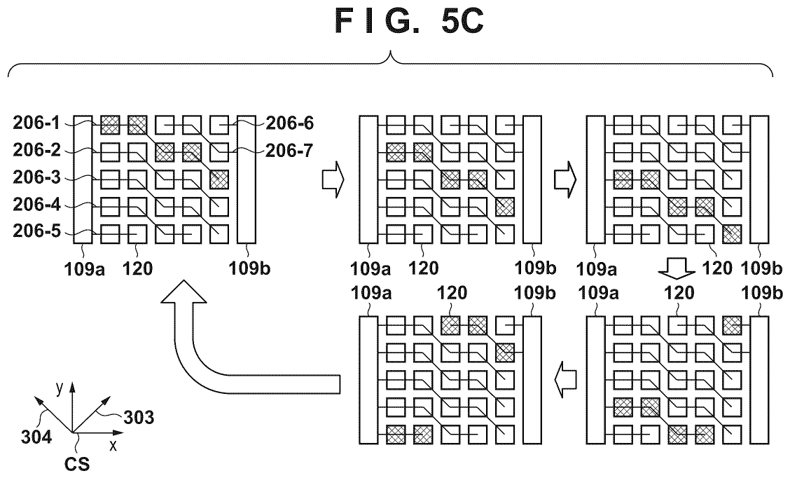

With reference to FIG. 5A, a timing for the driving circuit 110 (more specifically, the row selection circuits 109a and 109b thereof) to select the pixel circuit 120 will be described. As described above, a pixel signal is written in the pixel circuit 120 selected by the driving circuit 110. In FIG. 5A, the pixel circuits 120 selected at a given timing are hatched, and the pixel circuits 120 not selected at the given timing are not hatched.

As shown in the upper left of FIG. 5A, at a given timing, the driving circuit 110 selects the pixel circuits 120 connected to the scanning line 206-1. As shown in the upper middle of FIG. 5A, at the next timing, the driving circuit 110 selects the pixel circuits 120 connected to either the scanning line 206-2 or the scanning line 206-6. As shown in the upper right of FIG. 5A, at the next timing, the driving circuit 110 selects the pixel circuits 120 connected to either the scanning line 206-3 or the scanning line 206-7. As shown in the lower right of FIG. 5A, at the next timing, the driving circuit 110 selects the pixel circuits 120 connected to either the scanning line 206-4 or the scanning line 206-8. As shown in the lower middle of FIG. 5A, at the next timing, the driving circuit 110 selects the pixel circuits 120 connected to either the scanning line 206-5 or the scanning line 206-9. By the above-described operations, display data for one frame is displayed. The driving circuit 110 can display a moving image by repeating the above-described operations.

In the above-described operations, the number of the pixel circuits 120 selected from each pixel row at the same timing by the driving circuit 110 is one or less (more specifically, always one). Further, the number of the pixel circuits 120 selected from each pixel column at the same timing by the driving circuit 110 is one or less (more specifically, always one). Therefore, two or more pixel circuits 120 selected at the same timing by the driving circuit 110 are distributed and connected to two or more power supply lines 401 or two or more power supply lines 402. With this, it is possible to reduce the influence (for example, smear) on the light emission of other pixel circuits 120, that is caused by a voltage drop which occurs when writing a large pixel signal in a specific pixel circuit 120.

The driving circuit 110 may select the respective pixel circuits 120 by a Multi Line Selection (MLS) method. For example, the driving circuit 110 may select two pixel circuits 120 from each pixel column at each timing, thereby scanning the plurality of pixel circuits 120. The driving circuit 110 may change, for each frame, the pair of two pixel circuits 120 to be selected from each pixel column at the same timing. In the MLS method, the number of the pixel circuits 120 selected from each pixel row at the same timing by the driving circuit 110 is two or less (more specifically, always two). Further, the number of the pixel circuits 120 selected from each pixel column at the same timing by the driving circuit 110 is two or less (more specifically, always two). Even in this case, it is possible to reduce the influence (for example, smear) on the light emission of other pixel circuits 120, that is caused by a voltage drop which occurs when writing a large pixel signal in a specific pixel circuit 120.

As shown in FIG. 5A, the plurality of scanning lines 206 can have different lengths. Therefore, the driving circuit 110 may supply a selection signal with a higher driving force to the longer scanning line 206. For example, the driving circuit 110 may supply a selection signal with a higher driving force to the scanning line 206-1 than the scanning line 206-2.

With reference to FIG. 5B, the connection arrangement of the scanning lines 206 and the operation of the driving circuit 110 according to a modification will be described. In the example shown in FIG. 5B, at least one of the plurality of scanning lines 206 (more specifically, the scanning lines 206-2 to 206-6 and 206-8) includes a portion obliquely intersecting both the x-axis direction and the y-axis direction. More specifically, each of these scanning lines 206 includes a portion extending along the direction 303 and a portion extending along the direction 304.

The driving circuit 110 sequentially selects the respective pixel circuits 120 as shown in FIG. 5B. In this operation, the number of the pixel circuits 120 selected from each pixel row at the same timing by the driving circuit 110 is two or less (more specifically, one or two). Further, the number of the pixel circuits 120 selected from each pixel column at the same timing by the driving circuit 110 is one or less (more specifically, always one). In the arrangement shown in FIG. 5B, the scanning line 206-6 and the scanning line 206-8 may be connected, and the scanning line 206-7 and the scanning line 206-9 may be connected. In this case, one of the row selection circuit 109a and the row selection circuit 109b may be omitted.

With reference to FIG. 5C, the connection arrangement of the scanning lines 206 and the operation of the driving circuit 110 according to another modification will be described. In the example shown in FIG. 5C, at least one of the plurality of scanning lines 206 (more specifically, the scanning lines 206-1 to 206-4 and 206-7) includes a portion obliquely intersecting both the x-axis direction and the y-axis direction. More specifically, each of these scanning lines 206 includes a portion extending along the direction 304. Each of these scanning lines 206 further includes a portion extending along the x-axis direction.

The driving circuit 110 sequentially selects the respective pixel circuits 120 as shown in FIG. 5C. In this operation, the number of the pixel circuits 120 selected from each pixel row at the same timing by the driving circuit 110 is two or less (more specifically, one or two). Further, the number of the pixel circuits 120 selected from each pixel column at the same timing by the driving circuit 110 is one or less (more specifically, always one). In the arrangement shown in FIG. 5C, the scanning line 206-4 and the scanning line 206-6 may be connected, and the scanning line 206-5 and the scanning line 206-7 may be connected. In this case, one of the row selection circuit 109a and the row selection circuit 109b may be omitted.

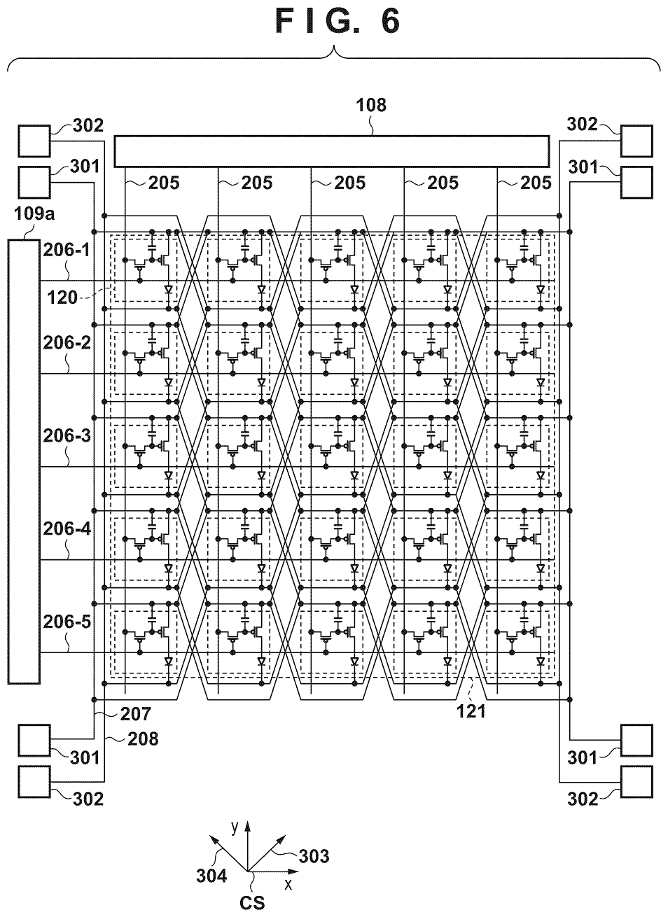

With reference to an equivalent circuit diagram of FIG. 6, an example of the arrangement of the signal line 205, the scanning line 206, the power supply line 207, and the ground line 208 will be described. Regarding points that may be similar to those in the equivalent circuit diagram of FIG. 3, a duplicated description will be omitted.

The light emitting device 100 includes a plurality of scanning lines 206. Selection signals are supplied to the plurality of pixel circuits 120 through the plurality of scanning lines 206. In FIG. 6, to discriminate the plurality of scanning lines 206 from each other, a suffix is added thereto, like scanning lines 206-1 to 206-5. Each of the scanning lines 206-1 to 206-5 is connected to two or more pixel circuits 120 arranged along the x-axis direction among the plurality of pixel circuits 120. For example, the scanning line 206-1 is connected to the pixel circuits 120 located in the first row from the top. The scanning line 206-2 is connected to the pixel circuits 120 located in the second row from the top. This also applies to other scanning lines 206. At least one of the plurality of scanning lines 206 (more specifically, the scanning lines 206-1 to 206-5) includes a portion obliquely intersecting both the direction 303 and the direction 304. More specifically, each of these scanning lines 206 includes a portion extending along the x-axis direction.

One end of each of the scanning lines 206-1 to 206-5 is connected to the row selection circuit 109a. The row selection circuit 109b is not arranged in the example shown in FIG. 6. Instead, the other end of each of the scanning lines 206-1 to 206-5 may be connected to the row selection circuit 109b.

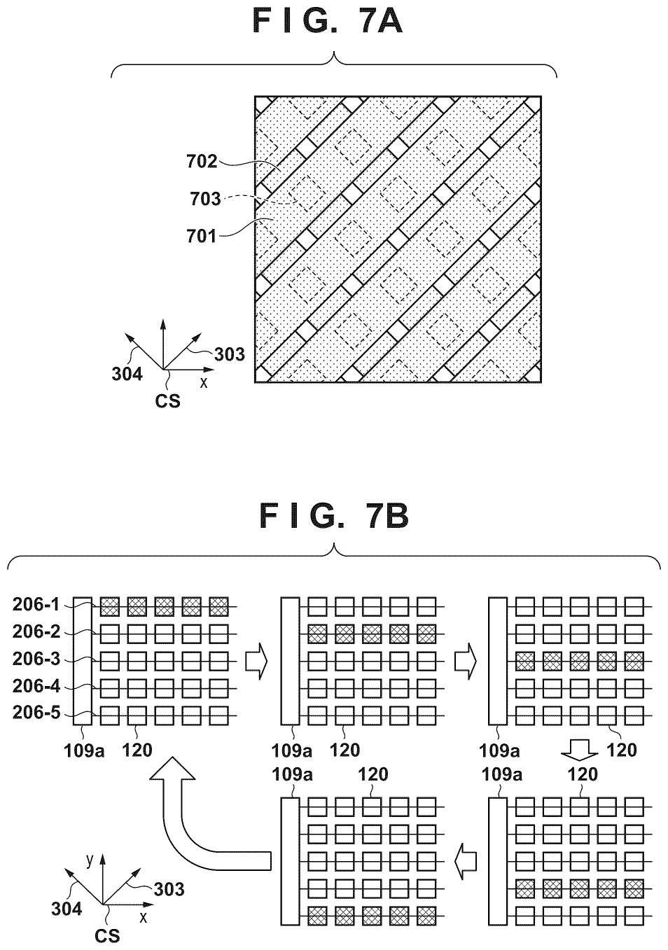

With reference to a layout diagram of FIG. 7A, a specific example of the arrangement of the power supply line 207 will be described. The ground line 208 may have a layout similar to that of the power supply line 207. FIG. 7A shows the layout of the power supply line 207 at a position overlapping the pixel region 121.

In the example shown in FIG. 7A, the power supply line 207 is formed by a plurality of power supply lines 701 and a plurality of power supply lines 702. The plurality of power supply lines 701 and the plurality of power supply lines 702 are connected to each other by a plurality of plugs 703. In FIG. 7A, only one of the plurality of power supply lines 701, only one of the plurality of power supply lines 702, and only one of the plurality of plugs 703 are given reference numerals, respectively.

Each of the plurality of power supply lines 701 extends in the direction 303 in the portion overlapping the plurality of pixel circuits 120. Each of the plurality of power supply lines 702 extends in the direction 304 in the portion overlapping the plurality of pixel circuits 120. The plurality of power supply lines 701 are formed in one wiring layer, and the plurality of power supply lines 702 are formed in another wiring layer. Either one of the wiring layer where the plurality of power supply lines 701 are formed and the wiring layer where the plurality of power supply lines 702 are formed may be arranged on the lower side (that is, near the substrate). The plurality of power supply lines 701 may be connected to the electrode pad 301 through another power supply line arranged outside the pixel region 121. The plurality of power supply lines 702 may be connected to the electrode pad 301 through another power supply line arranged outside the pixel region 121.

One power supply line 701 may be connected to one pixel circuit 120 in each pixel column. Instead, one power supply line 701 may be connected to two or more pixel circuits 120 in each pixel column. Further, one power supply line 701 may be connected to one pixel circuit 120 in each pixel row. Instead, one power supply line 701 may be connected to two or more pixel circuits 120 in each pixel row. This also applies to the power supply line 702.

In the example shown in FIG. 7A, the plurality of power supply lines 701 and the plurality of power supply lines 702 form the grid power supply lines 207. Instead, either the plurality of power supply lines 701 or the plurality of power supply lines 702 may be omitted.

With reference to FIG. 7B, a timing for the driving circuit 110 (more specifically, the row selection circuits 109a and 109b thereof) to select the pixel circuit 120 will be described. As described above, a pixel signal is written in the pixel circuit 120 selected by the driving circuit 110. In FIG. 7B, the pixel circuits 120 selected at a given timing are hatched, and the pixel circuits 120 not selected at the given timing are not hatched.

As shown in the upper left of FIG. 7B, at a given timing, the driving circuit 110 selects the pixel circuits 120 connected to the scanning line 206-1. As shown in the upper middle of FIG. 7B, at the next timing, the driving circuit 110 selects the pixel circuits 120 connected to the scanning line 206-2. As shown in the upper right of FIG. 7B, at the next timing, the driving circuit 110 selects the pixel circuits 120 connected to the scanning line 206-3. As shown in the lower right of FIG. 7B, at the next timing, the driving circuit 110 selects the pixel circuits 120 connected to the scanning line 206-4. As shown in the lower middle of FIG. 7B, at the next timing, the driving circuit 110 selects the pixel circuits 120 connected to the scanning line 206-5. By the above-described operations, display data for one frame is displayed. The driving circuit 110 can display a moving image by repeating the above-described operations.

In the above-described operations, the number of the pixel circuits 120 selected from two or more pixel circuits arranged along the direction 303 among the plurality of pixel circuits 120 at the same timing by the driving circuit 110 is one or less (more specifically, always one). Further, the number of the pixel circuits 120 selected from two or more pixel circuits arranged along the direction 304 among the plurality of pixel circuits 120 at the same timing by the driving circuit 110 is one or less (more specifically, always one). Therefore, two or more pixel circuits 120 which are selected at the same timing by the driving circuit 110 are distributed and connected to two or more power supply lines 701 or two or more power supply lines 702. With this, it is possible to reduce the influence (for example, smear) on the light emission of other pixel circuits 120, that is caused by a voltage drop which occurs when writing a large pixel signal in a specific pixel circuit 120.

The driving circuit 110 may select the respective pixel circuits 120 by an MLS method. In the MLS method, the number of the pixel circuits 120 to be selected from each pixel row at the same timing by the driving circuit 110 is two or less (more specifically, always two). Further, the number of the pixel circuits 120 to be selected from each pixel column at the same timing by the driving circuit 110 is two or less (more specifically, always two). Even in this case, it is possible to reduce the influence (for example, smear) on the light emission of other pixel circuits 120, that is caused by a voltage drop which occurs when writing a large pixel signal in a specific pixel circuit 120.

Here, application examples in which the light emitting device 100 according to this embodiment is applied to an image forming device, a display device, a photoelectric conversion device, an electronic apparatus, an illumination device, a moving body, and a wearable device will be described with reference to FIGS. 8A to 16B. The description will be given assuming that, for example, an organic light emitting element such as an organic EL element using an organic light emitting material is arranged in the pixel circuit 120 of the light emitting device 100. Details of each component arranged in the pixel circuit 120 of the light emitting device 100 described above will be described first, and the application examples will be described after that.

The organic light emitting element according to an embodiment of the present invention includes a first electrode, a second electrode, and an organic compound layer arranged between these electrodes. One of the first electrode and the second electrode is an anode, and the other is a cathode. In the organic light emitting element according to this embodiment, the organic compound layer may be either a single layer or a stacked body formed by a plurality of layers as long as it includes a light emitting layer. Here, if the organic compound layer is a stacked body formed from a plurality of layers, the organic compound layer may include a hole injection layer, a hole transport layer, an electron blocking layer, a hole/exciton blocking layer, an electron transport layer, an electron injection layer, and the like in addition to the light emitting layer. The light emitting layer may be a single layer or a stacked body formed from a plurality of layers. If the light emitting layer includes a plurality of layers, a charge generation layer may be arranged between the light emitting layers. The charge generation layer may be made of a compound having the LUMO lower than that of the hole transport layer, and the LUMO of the charge generation layer may be lower than the HOMO of the hole transport layer. Here, the molecular orbital energy of the organic compound layer may be the molecular orbital energy of the organic compound with the largest weight ratio in the organic compound layer.

The description is given here assuming that the closer the HOMO and LUMO are to the vacuum level, the “higher” they are. When the LUMO of the charge generation layer is lower than the HOMO of the hole transport layer, the LUMO of the charge generation layer is closer to the vacuum level than the HOMO of the hole transport layer.

The HOMO and LUMO in this specification can be calculated using molecular orbital calculation. The molecular orbital calculation is executed by a Density Functional Theory (DFT) or the like. A functional may be calculated using B3LYP, and a basic function may be calculated using 6-31G *. Note that molecular orbital calculation can be executed using, for example, Gaussian 09(Gaussian 09, Revision C.01, M. J. Frisch, G. W. Trucks, H. B. Schlegel, G. E. Scuseria, M. A. Robb, J. R. Cheeseman, G. Scalmani, V. Barone, B. Mennucci, G. A. Petersson, H. Nakatsuji, M. Caricato, X. Li, H. P. Hratchian, A. F. Izmaylov, J. Bloino, G. Zheng, J. L. Sonnenberg, M. Hada, M. Ehara, K. Toyota, R. Fukuda, J. Hasegawa, M. Ishida, T. Nakajima, Y. Honda, O. Kitao, H. Nakai, T. Vreven, J. A. Montgomery Jr., J. E. Peralta, F. Ogliaro, M. Bearpark, J. J. Heyd, E. Brothers, K. N. Kudin, V. N. Staroverov, T. Keith, R. Kobayashi, J. Normand, K. Raghavachari, A. Rendell, J. C. Burant, S. S. Iyengar, J. Tomasi, M. Cossi, N. Rega, J. M. Millam, M. Klene, J. E. Knox, J. B. Cross, V. Bakken, C. Adamo, J. Jaramillo, R. Gomperts, R. E. Stratmann, O. Yazyev, A. J. Austin, R. Cammi, C. Pomelli, J. W. Ochterski, R. L. Martin, K. Morokuma, V. G. Zakrzewski, G. A. Voth, P. Salvador, J. J. Dannenberg, S. Dapprich, A. D. Daniels, O. Farkas, J. B. Foresman, J. V. Ortiz, J. Cioslowski, and D. J. Fox, Gaussian, Inc., Wallingford CT, 2010.)

The HOMO and LUMO in this specification can be calculated using the ionization potential and band gap. The HOMO can be estimated by measuring the ionization potential. The ionization potential can be measured by dissolving the compound to be measured in a solvent such as toluene and using a measuring device such as AC-3. The band gap can be measured by dissolving the compound to be measured in a solvent such as toluene and irradiating it with excitation light. The band gap can be measured by measuring the absorption edge of the excitation light. Alternatively, the band gap can be measured by depositing the compound to be measured on a substrate such as glass, and exposing the deposited film to excitation light. The band gap can be measured by measuring the absorption edge of the absorption spectrum at which the deposited film absorbs excitation light.

The LUMO can be calculated using the band gap and ionization potential value. The LUMO can be estimated by subtracting the ionization potential value from the band gap.

The LUMO can also be estimated from the reduction potential. For example, the one-electron reduction potential is estimated using cyclic voltammetry (CV) measurement. The CV measurement can be performed, for example, in a DMF solution of 0.1 M tetrabutylammonium perchlorate using a reference electrode of Ag/Ag+, a counter electrode of Pt, and a working electrode of glassy carbon. The LUMO can be estimated by adding −4.8 eV to the difference between the reduction potential of the obtained compound and that of ferrocene.

In the organic light emitting element according to an embodiment of the present invention, if an organic compound according to this embodiment is contained in the light emitting layer, the light emitting layer may be a layer made of only the organic compound according to this embodiment, or may be a layer made of the organic metal complex according to this embodiment and another compound.

### Arrangement of Organic Light Emitting Element

The organic light emitting element is provided by forming an insulating layer, a first electrode, an organic compound layer, and a second electrode on a substrate. A protection layer, a color filter, a microlens, and the like may be provided on a cathode. If a color filter is provided, a planarizing layer may be provided between the protection layer and the color filter. The planarizing layer can be formed using acrylic resin or the like. The same applies to a case where a planarizing layer is provided between the color filter and the microlens.

### Substrate

Quartz, glass, a silicon wafer, a resin, a metal, or the like may be used as a substrate. Furthermore, a switching element such as a transistor, a wiring pattern, and the like may be provided on the substrate, and an insulating layer may be provided thereon. The insulating layer may be made of any material as long as a contact hole can be formed so that the wiring pattern can be formed between the first electrode and the substrate and insulation from the unconnected wiring pattern can be ensured. For example, a resin such as polyimide, silicon oxide, silicon nitride, or the like may be used for the insulating layer.

### Electrode

A pair of electrodes can be used as the electrodes. The pair of electrodes can be an anode and a cathode. If an electric field is applied in the direction in which the organic light emitting element emits light, the electrode having a high potential is the anode, and the other is the cathode. It can also be said that the electrode that supplies holes to the light emitting layer is the anode and the electrode that supplies electrons is the cathode.

As the constituent material of the anode, a material having a large work function may be selected. For example, a metal such as gold, platinum, silver, copper, nickel, palladium, cobalt, selenium, vanadium, or tungsten, a mixture containing some of them, an alloy obtained by combining some of them, or a metal oxide such as tin oxide, zinc oxide, indium oxide, indium tin oxide (ITO), or zinc indium oxide can be used. Furthermore, a conductive polymer such as polyaniline, polypyrrole, or polythiophene can also be used as the constituent material of the anode.

One of these electrode materials may be used singly, or two or more of them may be used in combination. The anode may be formed by a single layer or a plurality of layers.

If the electrode is used as a reflective electrode, for example, chromium, aluminum, silver, titanium, tungsten, molybdenum, an alloy thereof, a stacked layer thereof, or the like can be used. The above materials can function as a reflective film having no role as an electrode. If a transparent electrode is used as the electrode, an oxide transparent conductive layer made of indium tin oxide (ITO), indium zinc oxide, or the like can be used, but the present invention is not limited thereto. A photolithography technique can be used to form the electrode.

On the other hand, as the constituent material of the cathode, a material having a small work function may be selected. Examples of the material include an alkali metal such as lithium, an alkaline earth metal such as calcium, a metal such as aluminum, titanium, manganese, silver, lead, or chromium, and a mixture containing some of them. Alternatively, an alloy obtained by combining these metals can also be used. For example, a magnesium-silver alloy, an aluminum-lithium alloy, an aluminum-magnesium alloy, a silver-copper alloy, a zinc-silver alloy, or the like can be used. A metal oxide such as indium tin oxide (ITO) can also be used. One of these electrode materials may be used singly, or two or more of them may be used in combination. The cathode may have a single-layer structure or a multilayer structure. Silver may be used as the cathode. To suppress aggregation of silver, a silver alloy may be used. The ratio of the alloy is not limited as long as aggregation of silver can be suppressed. For example, the ratio between silver and another metal may be 1:1, 3:1, or the like.

The cathode may be a top emission element using an oxide conductive layer made of ITO or the like, or may be a bottom emission element using a reflective electrode made of aluminum (Al) or the like, and is not particularly limited. The method of forming the cathode is not particularly limited, but if direct current sputtering or alternating current sputtering is used, the good coverage is achieved for the film to be formed, and the resistance of the cathode can be lowered.

### Pixel Isolation Layer

A pixel isolation layer may be formed by a so-called silicon oxide, such as silicon nitride (SiN), silicon oxynitride (SiON), or silicon oxide (SiO), formed using a Chemical Vapor Deposition (CVD) method. To increase the resistance in the in-plane direction of the organic compound layer, the organic compound layer, especially the hole transport layer may be thinly deposited on the side wall of the pixel isolation layer. More specifically, the organic compound layer can be deposited so as to have a thin film thickness on the side wall by increasing the taper angle of the side wall of the pixel isolation layer or the film thickness of the pixel isolation layer to increase vignetting during vapor deposition.

On the other hand, the taper angle of the side wall of the pixel isolation layer or the film thickness of the pixel isolation layer can be adjusted to the extent that no space is formed in the protection layer formed on the pixel isolation layer. Since no space is formed in the protection layer, it is possible to reduce generation of defects in the protection layer. Since generation of defects in the protection layer is reduced, a decrease in reliability caused by generation of a dark spot or occurrence of a conductive failure of the second electrode can be reduced.

According to this embodiment, even if the taper angle of the side wall of the pixel isolation layer is not acute, it is possible to effectively suppress leakage of charges to an adjacent pixel. As a result of this consideration, it has been found that the taper angle of 60° (inclusive) to 90° (inclusive) can sufficiently reduce the occurrence of defects. The film thickness of the pixel isolation layer may be 10 nm (inclusive) to 150 nm (inclusive). A similar effect can be obtained in an arrangement including only pixel electrodes without the pixel isolation layer. However, in this case, the film thickness of the pixel electrode is set to be equal to or smaller than half the film thickness of the organic layer or the end portion of the pixel electrode is formed to have a forward tapered shape of less than 60°. With this, short circuit of the organic light emitting element can be reduced.

Furthermore, in a case where the first electrode is the cathode and the second electrode is the anode, a high color gamut and low-voltage driving can be achieved by forming the electron transport material and charge transport layer and forming the light emitting layer on the charge transport layer.

### Organic Compound Layer

The organic compound layer may be formed by a single layer or a plurality of layers. If the organic compound layer includes a plurality of layers, the layers can be called a hole injection layer, a hole transport layer, an electron blocking layer, a light emitting layer, a hole blocking layer, an electron transport layer, and an electron injection layer in accordance with the functions of the layers. The organic compound layer is mainly formed from an organic compound but may contain inorganic atoms and an inorganic compound. For example, the organic compound layer may contain copper, lithium, magnesium, aluminum, iridium, platinum, molybdenum, zinc, or the like. The organic compound layer may be arranged between the first and second electrodes, and may be arranged in contact with the first and second electrodes. If a plurality of light emitting layers are provided, a charge generation portion may be arranged between the first light emitting layer and the second light emitting layer. The charge generation portion may contain an organic compound with a lowest unoccupied molecular orbital energy (LUMO) of −5.0 eV or less. The same applies to a case where a charge generation portion is provided between the second light emitting layer and the third light emitting layer.

### Protection Layer

A protection layer may be provided on the cathode. For example, by adhering glass provided with a moisture absorbing agent on the cathode, permeation of water or the like into the organic compound layer can be suppressed and occurrence of display defects can be suppressed. Furthermore, as another embodiment, a passivation layer made of silicon nitride or the like may be provided on the cathode to suppress permeation of water or the like into the organic compound layer. For example, the protection layer can be formed by forming the cathode, transferring it to another chamber without breaking the vacuum, and forming silicon nitride having a thickness of 2 μm by the CVD method. The protection layer may be provided using an atomic layer deposition (ALD) method after deposition of the protection layer using the CVD method. The material of the protection layer by the ALD method is not limited but can be silicon nitride, silicon oxide, aluminum oxide, or the like. Silicon nitride may further be formed by the CVD method on the protection layer formed by the ALD method. The protection layer formed by the ALD method may have a film thickness smaller than that of the protection layer formed by the CVD method. More specifically, the film thickness of the protection layer formed by the ALD method may be 50% or less, or 10% or less of that of the protection layer formed by the CVD method.

### Color Filter

A color filter may be provided on the protection layer. For example, a color filter considering the size of the organic light emitting element may be provided on another substrate, and the substrate with the color filter formed thereon may be bonded to the substrate with the organic light emitting element provided thereon. Alternatively, for example, a color filter may be patterned on the above-described protection layer using a photolithography technique. The color filter may be formed from a polymeric material.

### Planarizing Layer

A planarizing layer may be arranged between the color filter and the protection layer. The planarizing layer is provided to reduce unevenness of the layer below the planarizing layer. The planarizing layer may be called a material resin layer without limiting the purpose of the layer. The planarizing layer may be formed from an organic compound, and may be made of a low-molecular material or a polymeric material. In consideration of reduction of unevenness, a polymeric organic compound may be used for the planarizing layer.

The planarizing layers may be provided above and below the color filter. In that case, the same or different constituent materials may be used for these planarizing layers. More specifically, examples of the material of the planarizing layer include polyvinyl carbazole resin, polycarbonate resin, polyester resin, ABS resin, acrylic resin, polyimide resin, phenol resin, epoxy resin, silicone resin, and urea resin.

### Microlens

The organic light emitting device may include an optical member such as a microlens on the light emission side. The microlens can be made of acrylic resin, epoxy resin, or the like. The microlens can aim to increase the amount of light extracted from the organic light emitting device and control the direction of light to be extracted. The microlens can have a hemispherical shape. If the microlens has a hemispherical shape, among tangents contacting the hemisphere, there is a tangent parallel to the insulating layer, and the contact between the tangent and the hemisphere is the vertex of the microlens. The vertex of the microlens can be decided in the same manner even in an arbitrary sectional view. That is, among tangents contacting the semicircle of the microlens in a sectional view, there is a tangent parallel to the insulating layer, and the contact between the tangent and the semicircle is the vertex of the microlens.

Furthermore, the middle point of the microlens can also be defined. In the section of the microlens, a line segment from a point at which an arc shape ends to a point at which another arc shape ends is assumed, and the middle point of the line segment can be called the middle point of the microlens. A section for determining the vertex and the middle point may be a section perpendicular to the insulating layer.

The microlens includes a first surface including a convex portion and a second surface opposite to the first surface. The second surface can be arranged on the functional layer (light emitting layer) side of the first surface. For this arrangement, the microlens needs to be formed on the light emitting device. If the functional layer is an organic layer, a process which produces high temperature in the manufacturing step of the microlens may be avoided. In addition, if it is configured to arrange the second surface on the functional layer side of the first surface, all the glass transition temperatures of an organic compound forming the organic layer may be 100° C. or more. For example, 130° C. or more is suitable.

### Counter Substrate

A counter substrate may be arranged on the planarizing layer. The counter substrate is called a counter substrate because it is provided at a position corresponding to the above-described substrate. The constituent material of the counter substrate can be the same as that of the above-described substrate. If the above-described substrate is the first substrate, the counter substrate can be the second substrate.

### Organic Layer

The organic compound layer (hole injection layer, hole transport layer, electron blocking layer, light emitting layer, hole blocking layer, electron transport layer, electron injection layer, and the like) forming the organic light emitting element according to an embodiment of the present disclosure may be formed by the method to be described below.

The organic compound layer forming the organic light emitting element according to the embodiment of the present disclosure can be formed by a dry process using a vacuum deposition method, an ionization deposition method, a sputtering method, a plasma method, or the like. Instead of the dry process, a wet process that forms a layer by dissolving a solute in an appropriate solvent and using a well-known coating method (for example, a spin coating method, a dipping method, a casting method, an LB method, an inkjet method, or the like) can be used.

Here, when the layer is formed by a vacuum deposition method, a solution coating method, or the like, crystallization or the like hardly occurs and excellent temporal stability is obtained. Furthermore, when the layer is formed using a coating method, it is possible to form the film in combination with a suitable binder resin.

Examples of the binder resin include polyvinyl carbazole resin, polycarbonate resin, polyester resin, ABS resin, acrylic resin, polyimide resin, phenol resin, epoxy resin, silicone resin, and urea resin. However, the binder resin is not limited to them.

One of these binder resins may be used singly as a homopolymer or a copolymer, or two or more of them may be used in combination. Furthermore, additives such as a well-known plasticizer, antioxidant, and an ultraviolet absorber may also be used as needed.

### Pixel Circuit

The light emitting device can include a pixel circuit connected to the light emitting element. The pixel circuit may be an active matrix circuit that individually controls light emission of the first and second light emitting elements. The active matrix circuit may be a voltage or current programing circuit. A driving circuit includes a pixel circuit for each pixel. The pixel circuit can include a light emitting element, a transistor for controlling light emission luminance of the light emitting element, a transistor for controlling a light emission timing, a capacitor for holding the gate voltage of the transistor for controlling the light emission luminance, and a transistor for connection to GND without intervention of the light emitting element.

The light emitting device includes a display region and a peripheral region arranged around the display region. The light emitting device includes the pixel circuit in the display region and a display control circuit in the peripheral region. The mobility of the transistor forming the pixel circuit may be smaller than that of a transistor forming the display control circuit.

The slope of the current-voltage characteristic of the transistor forming the pixel circuit may be smaller than that of the current-voltage characteristic of the transistor forming the display control circuit. The slope of the current-voltage characteristic can be measured by a so-called Vg-Ig characteristic.

The transistor forming the pixel circuit is a transistor connected to the light emitting element such as the first light emitting element.

### Pixel

The organic light emitting device includes a plurality of pixels. Each pixel includes sub-pixels that emit light components of different colors. The sub-pixels may include, for example, R, G, and B emission colors, respectively. In each pixel, a region also called a pixel opening emits light. The pixel opening can have a size of 5 μm (inclusive) to 15 um (inclusive). More specifically, the pixel opening can have a size of 11 μm, 9.5 μm, 7.4 μm, 6.4 μm, or the like.

A distance between the sub-pixels can be 10 μm or less, and can be, more specifically, 8 μm, 7.4 μm, or 6.4 μm.

The pixels can have a known arrangement form in a plan view. For example, the pixels may have a stripe arrangement, a delta arrangement, a pentile arrangement, or a Bayer arrangement. The shape of each sub-pixel in a plan view may be any known shape. For example, a quadrangle such as a rectangle or a rhombus, a hexagon, or the like may be possible. A shape which is not a correct shape but is close to a rectangle is included in a rectangle, as a matter of course. The shape of the sub-pixel and the pixel arrangement can be used in combination.

### Application of Organic Light Emitting Element of Embodiment of Present Disclosure

The organic light emitting element according to an embodiment of the present disclosure can be used as a constituent member of a display device or an illumination device. In addition, the organic light emitting element is applicable to the exposure light source of an electrophotographic image forming device, the backlight of a liquid crystal display device, a light emitting device including a color filter in a white light source, and the like.

The display device may be an image information processing device that includes an image input unit for inputting image information from an area CCD, a linear CCD, a memory card, or the like, and an information processing unit for processing the input information, and displays the input image on a display unit.

In addition, a display unit included in an image capturing device or an inkjet printer can have a touch panel function. The driving type of the touch panel function may be an infrared type, a capacitance type, a resistive film type, or an electromagnetic induction type, and is not particularly limited. The display device may be used for the display unit of a multifunction printer.

More details will be described next with reference to the accompanying drawings. FIG. 8A shows an example of the pixel circuit 120 arranged in the light emitting device 100. The pixel includes sub-pixels 810 (pixel circuits 120). The sub-pixels are divided into sub-pixels 810R, 810G, and 810B by emitted light components. The light emission colors may be discriminated by the wavelengths of light components emitted from the light emitting layers, or light emitted from each sub-pixel may be selectively transmitted or undergo color conversion by a color filter or the like. Each sub-pixel includes a reflective electrode 802 as the first electrode on an interlayer insulating layer 801, an insulating layer 803 covering the end of the reflective electrode 802, an organic compound layer 804 covering the first electrode and the insulating layer, a transparent electrode 805 as the second electrode, a protection layer 806, and a color filter 807.

The interlayer insulating layer 801 can include a transistor and a capacitive element arranged in the interlayer insulating layer 801 or a layer below it. The transistor and the first electrode can electrically be connected via a contact hole (not shown) or the like.

The insulating layer 803 can also be called a bank or a pixel isolation film. The insulating layer 803 covers the end of the first electrode, and is arranged to surround the first electrode. A portion of the first electrode where no insulating layer 803 is arranged is in contact with the organic compound layer 804 to form a light emitting region.

The organic compound layer 804 includes a hole injection layer 841, a hole transport layer 842, a first light emitting layer 843, a second light emitting layer 844, and an electron transport layer 845.

The second electrode may be a transparent electrode, a reflective electrode, or a semi-transmissive electrode.

The protection layer 806 suppresses permeation of water into the organic compound layer. The protection layer is shown as a single layer but may include a plurality of layers. Each layer can be an inorganic compound layer or an organic compound layer.

The color filter 807 is divided into color filters 807R, 807G, and 807B by colors. The color filters can be formed on a planarizing film (not shown). A resin protection layer (not shown) may be arranged on the color filters. The color filters can be formed on the protection layer 806. Alternatively, the color filters can be provided on the counter substrate such as a glass substrate, and then the substrate may be bonded.

A display device 800 (corresponding to the above-described light emitting device 100) shown in FIG. 8B is provided with an organic light emitting element 826 and a TFT 818 as an example of a transistor. A substrate 811 of glass, silicon, or the like is provided and an insulating layer 812 is provided on the substrate 811. The active element such as the TFT 818 is arranged on the insulating layer, and a gate electrode 813, a gate insulating film 814, and a semiconductor layer 815 of the active element are arranged. The TFT 818 further includes the semiconductor layer 815, a drain electrode 816, and a source electrode 817. An insulating film 819 is provided on the TFT 818. The source electrode 817 and an anode 821 forming the organic light emitting element 826 are connected via a contact hole 820 formed in the insulating film.

A method of electrically connecting the electrodes (anode and cathode) included in the organic light emitting element 826 and the electrodes (source electrode and drain electrode) included in the TFT is not limited to that shown in FIG. 8B. That is, one of the anode and cathode and one of the source electrode and drain electrode of the TFT are electrically connected. The TFT indicates a thin-film transistor.

In the display device 800 shown in FIG. 8B, an organic compound layer is illustrated as one layer. However, an organic compound layer 822 may include a plurality of layers. A first protection layer 824 and a second protection layer 825 are provided on a cathode 823 to suppress deterioration of the organic light emitting element.

A transistor is used as a switching element in the display device 800 shown in FIG. 8B but may be used as another switching element.

The transistor used in the display device 800 shown in FIG. 8B is not limited to a transistor using a single-crystal silicon wafer, and may be a thin-film transistor including an active layer on an insulating surface of a substrate. Examples of the active layer include single-crystal silicon, amorphous silicon, non-single-crystal silicon such as microcrystalline silicon, and a non-single-crystal oxide semiconductor such as indium zinc oxide and indium gallium zinc oxide. Note that a thin-film transistor is also called a TFT element.

The transistor included in the display device 800 shown in FIG. 8B may be formed in the substrate such as a silicon substrate. Forming the transistor in the substrate means forming the transistor by processing the substrate such as a silicon substrate. That is, when the transistor is included in the substrate, it can be considered that the substrate and the transistor are formed integrally.

The light emission luminance of the organic light emitting element according to this embodiment can be controlled by the TFT which is an example of a switching element, and the plurality of organic light emitting elements can be provided in a plane to display an image with the light emission luminances of the respective elements. Here, the switching element according to this embodiment is not limited to the TFT, and may be a transistor formed from low-temperature polysilicon or an active matrix driver formed on the substrate such as a silicon substrate. The term “on the substrate” may mean “in the substrate”. Whether to provide a transistor in the substrate or use a TFT is selected based on the size of the display unit. For example, if the size is about 0.5 inch, the organic light emitting element is preferably provided on the silicon substrate.

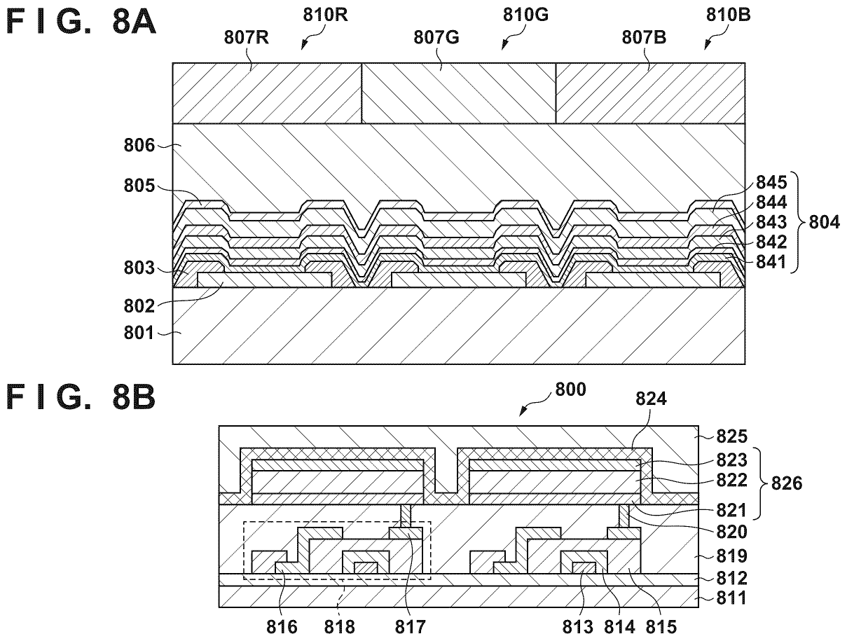

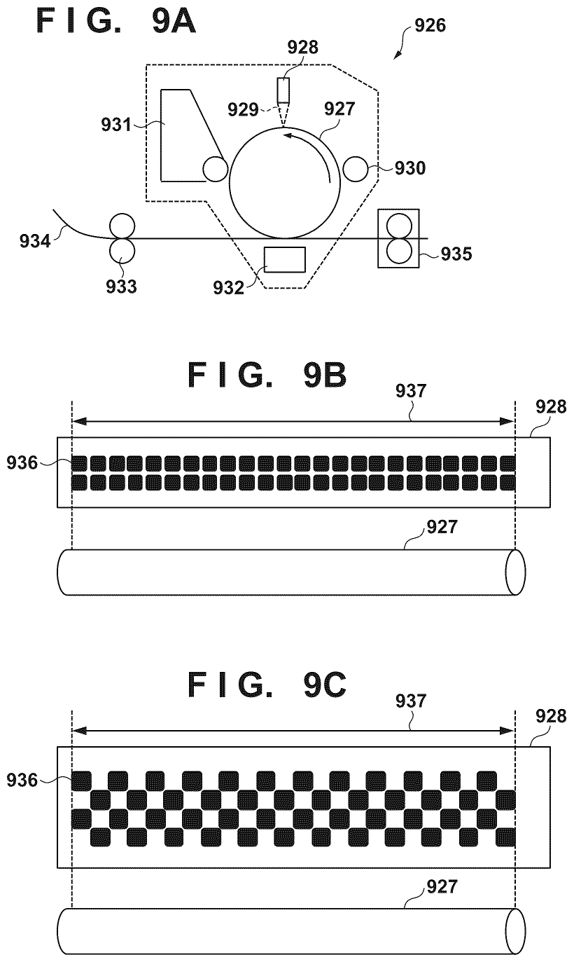

FIGS. 9A to 9C are schematic views showing an example of an image forming device using the light emitting device 100 according to this embodiment. An image forming device 926 shown in FIG. 9A includes a photosensitive member 927, an exposure light source 928, a developing unit 931, a charging unit 930, a transfer device 932, a conveyance unit 933 (a conveyance roller in the arrangement shown in FIG. 9A), and a fixing device 935.

Light 929 is emitted from the exposure light source 928, and an electrostatic latent image is formed on the surface of the photosensitive member 927. The light emitting device 100 can be applied to the exposure light source 928. The developing unit 931 can function as a developing device that includes a toner or the like as a developing agent and applies the developing agent to the exposed photosensitive member 927. The charging unit 930 charges the photosensitive member 927. The transfer device 932 transfers the developed image to a print medium 934. The conveyance unit 933 conveys the print medium 934. The print medium 934 can be, for example, paper, a film, or the like. The fixing device 935 fixes the image formed on the print medium.

Each of FIGS. 9B and 9C is a schematic view showing a form in which a plurality of light emitting units 936 are arranged in the exposure light source 928 along the longitudinal direction of a long substrate. The light emitting device 100 can be applied to each of the light emitting units 936. That is, a plurality of the pixel circuits 120 are arranged along the longitudinal direction of the substrate. A direction 937 is a direction parallel to the axis of the photosensitive member 927. This column direction matches the direction of the axis upon rotating the photosensitive member 927. This direction 937 can also be referred to as the long-axis direction of the photosensitive member 927.

FIG. 9B shows a form in which the light emitting units 936 are arranged along the long-axis direction of the photosensitive member 927. FIG. 9C shows a form, which is a modification of the arrangement of the light emitting units 936 shown in FIG. 9B, in which the light emitting units 936 are arranged in the column direction alternately between the first column and the second column. The light emitting units 936 are arranged at different positions in the row direction between the first column and the second column. In the first column, the plurality of light emitting units 936 are arranged apart from each other. In the second column, the light emitting unit 936 is arranged at the position corresponding to the space between the light emitting units 936 in the first column. Furthermore, in the row direction, the plurality of light emitting units 936 are arranged apart from each other. The arrangement of the light emitting units 936 shown in FIG. 9C can be referred to as, for example, an arrangement in a grid pattern, an arrangement in a staggered pattern, or an arrangement in a checkered pattern.

FIG. 10 is a schematic view showing an example of the display device using the light emitting device 100 according to this embodiment. A display device 1000 can include a touch panel 1003, a display panel 1005, a frame 1006, a circuit board 1007, and a battery 1008 between an upper cover 1001 and a lower cover 1009. Flexible printed circuits (FPCs) 1002 and 1004 are respectively connected to the touch panel 1003 and the display panel 1005. Active elements such as transistors are arranged on the circuit board 1007. The battery 1008 is unnecessary if the display device 1000 is not a portable apparatus. Even when the display device 1000 is a portable apparatus, the battery 1008 need not be provided at this position. The light emitting device 100 can be applied to the display panel 1005. The pixel circuits 120 arranged in the light emitting device 100 functioning as the display panel 1005 operate in a state in which they are connected to the active elements such as transistors arranged on the circuit board 1007.

The display device 1000 shown in FIG. 10 can be used for a display unit of a photoelectric conversion device (also referred to as an image capturing device) including an optical unit having a plurality of lenses, and an image sensor for receiving light having passed through the optical unit and photoelectrically converting the light into an electric signal. The photoelectric conversion device can include a display unit for displaying information acquired by the image sensor. In addition, the display unit can be either a display unit exposed outside the photoelectric conversion device, or a display unit arranged in the finder. The photoelectric conversion device can be a digital camera or a digital video camera.

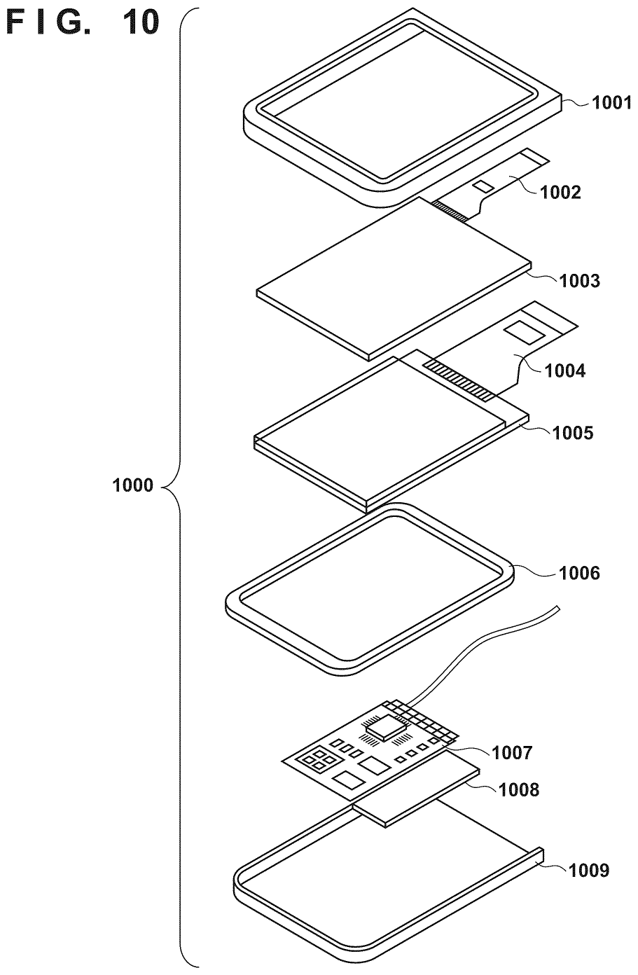

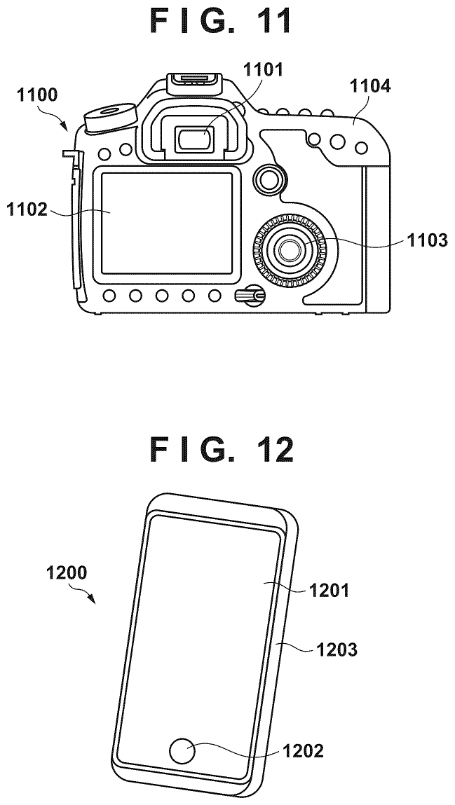

FIG. 11 is a schematic view showing an example of the photoelectric conversion device using the light emitting device 100 according to this embodiment. A photoelectric conversion device 1100 can include a viewfinder 1101, a rear display 1102, an operation unit 1103, and a housing 1104. The photoelectric conversion device 1100 can also be called an image capturing device. The light emitting device 100 according to this embodiment can be applied to the viewfinder 1101 or the rear display 1102 as a display unit. In this case, the light emitting device 100 can display not only an image to be captured but also environment information, image capturing instructions, and the like. Examples of the environment information are the intensity and direction of external light, the moving velocity of an object, and the possibility that an object is covered with an obstacle.

The timing suitable for image capturing is a very short time in many cases, so the information is preferably displayed as soon as possible. Therefore, the light emitting device 100 in which the pixel circuit 120 including the light emitting element using the organic light emitting material such as an organic EL element is arranged may be used for the viewfinder 1101 or the rear display 1102. This is so because the organic light emitting material has a high response speed. The light emitting device 100 using the organic light emitting material can be used for the devices that require a high display speed more preferably than for the liquid crystal display device.

The photoelectric conversion device 1100 includes an optical unit (not shown). This optical unit has a plurality of lenses, and forms an image on a photoelectric conversion element (not shown) that receives light having passed through the optical unit and is accommodated in the housing 1104. The focal points of the plurality of lenses can be adjusted by adjusting the relative positions. This operation can also automatically be performed.

The light emitting device 100 may be applied to a display unit of an electronic apparatus. At this time, the display unit can have both a display function and an operation function. Examples of the portable terminal are a portable phone such as a smartphone, a tablet, and a head mounted display.

FIG. 12 is a schematic view showing an example of an electronic apparatus using the light emitting device 100 according to this embodiment. An electronic apparatus 1200 includes a display unit 1201, an operation unit 1202, and a housing 1203. The housing 1203 can accommodate a circuit, a printed board having this circuit, a battery, and a communication unit. The operation unit 1202 can be a button or a touch-panel-type reaction unit. The operation unit 1202 can also be a biometric authentication unit that performs unlocking or the like by authenticating the fingerprint. The portable apparatus including the communication unit can also be regarded as a communication apparatus. The light emitting device 100 according to this embodiment can be applied to the display unit 1201.

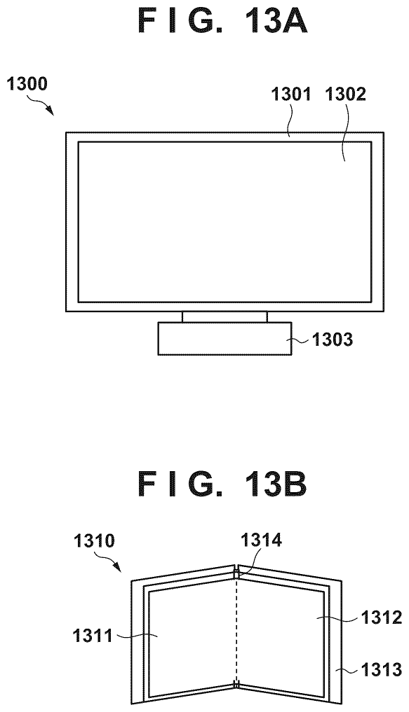

FIGS. 13A and 13B are schematic views showing examples of the display device using the light emitting device 100 according to this embodiment. FIG. 13A shows a display device such as a television monitor or a PC monitor. A display device 1300 includes a frame 1301 and a display unit 1302. The light emitting device 100 according to this embodiment can be applied to the display unit 1302. The display device 1300 can include a base 1303 that supports the frame 1301 and the display unit 1302. The base 1303 is not limited to the form shown in FIG. 13A. For example, the lower side of the frame 1301 may also function as the base 1303. In addition, the frame 1301 and the display unit 1302 can be bent. The radius of curvature in this case can be 5,000 mm (inclusive) to 6,000 mm (inclusive).

FIG. 13B is a schematic view showing another example of the display device using the light emitting device 100 according to this embodiment. A display device 1310 shown in FIG. 13B can be folded, and is a so-called foldable display device. The display device 1310 includes a first display unit 1311, a second display unit 1312, a housing 1313, and a bending point 1314. The light emitting device 100 according to this embodiment can be applied to each of the first display unit 1311 and the second display unit 1312. The first display unit 1311 and the second display unit 1312 can also be one seamless display device. The first display unit 1311 and the second display unit 1312 can be divided by the bending point. The first display unit 1311 and the second display unit 1312 can display different images, and can also display one image together.

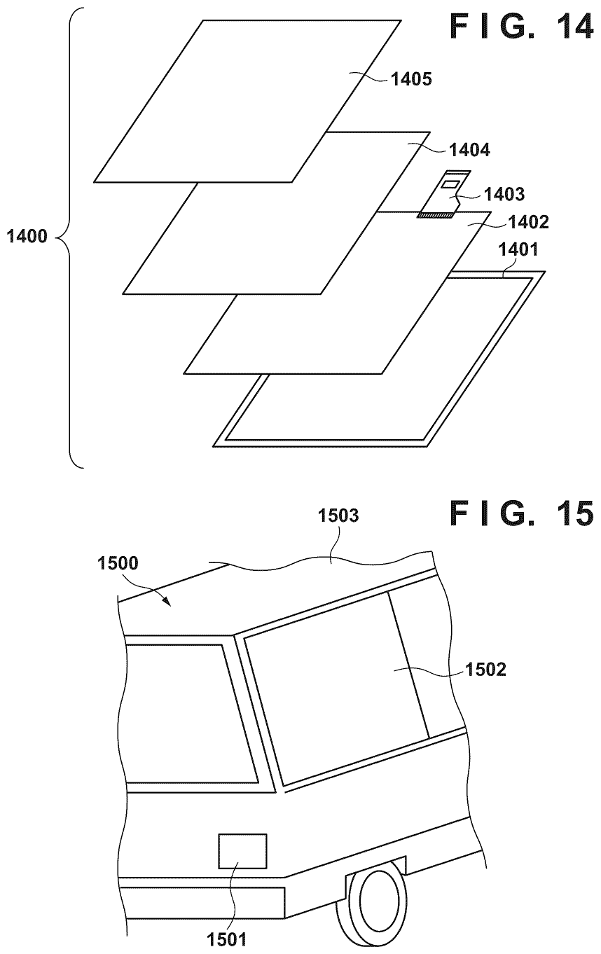

FIG. 14 is a schematic view showing an example of the illumination device using the light emitting device 100 according to this embodiment. An illumination device 1400 can include a housing 1401, a light source 1402, a circuit board 1403, an optical film 1404, and a light diffusing unit 1405. The light emitting device 100 according to this embodiment can be applied to the light source 1402. The optical film 1404 can be a filter that improves the color rendering of the light source. When performing lighting-up or the like, the light diffusing unit 1405 can throw the light of the light source over a broad range by effectively diffusing the light. The illumination device can also include a cover on the outermost portion, as needed. The illumination device 1400 can include both or one of the optical film 1404 and the light diffusing unit 1405.

The illumination device 1400 is, for example, a device for illuminating the interior of the room. The illumination device 1400 can emit white light, natural white light, or light of any color from blue to red. The illumination device 1400 can also include a light control circuit for controlling these light components. The illumination device 1400 can also include a power supply circuit connected to the light emitting device 100 functioning as the light source 1402. The power supply circuit is a circuit for converting an AC voltage into a DC voltage. White has a color temperature of 4,200 K, and natural white has a color temperature of 5,000 K. The illumination device 1400 may also include a color filter. In addition, the illumination device 1400 can include a heat radiation unit. The heat radiation unit radiates the internal heat of the device to the outside of the device, and examples are a metal having a high specific heat and liquid silicon.

FIG. 15 is a schematic view of an automobile having a taillight as an example of a vehicle lighting appliance using the light emitting device 100 according to this embodiment. An automobile 1500 has a taillight 1501, and can have a form in which the taillight 1501 is turned on when performing a braking operation or the like. The light emitting device 100 according to this embodiment can be used as a headlight serving as a vehicle lighting appliance. The automobile is an example of a moving body, and the moving body may be a ship, a drone, an aircraft, a railroad car, an industrial robot, or the like. The moving body may include a main body and a lighting appliance provided in the main body. The lighting appliance may be used to make a notification of the current position of the main body.

The light emitting device 100 according to this embodiment can be applied to the taillight 1501. The taillight 1501 can include a protection member for protecting the light emitting device 100 functioning as the taillight 1501. The material of the protection member is not limited as long as the material is a transparent material with a strength that is high to some extent, and an example is polycarbonate. The protection member may be made of a material obtained by mixing a furandicarboxylic acid derivative, an acrylonitrile derivative, or the like in polycarbonate.

The automobile 1500 can include a vehicle body 1503, and a window 1502 attached to the vehicle body 1503. This window can be a window for checking the front and back of the automobile, and can also be a transparent display such as a head-up display. For this transparent display, the light emitting device 100 according to this embodiment may be used. In this case, the constituent materials of the electrodes and the like of the light emitting device 100 are formed by transparent members.

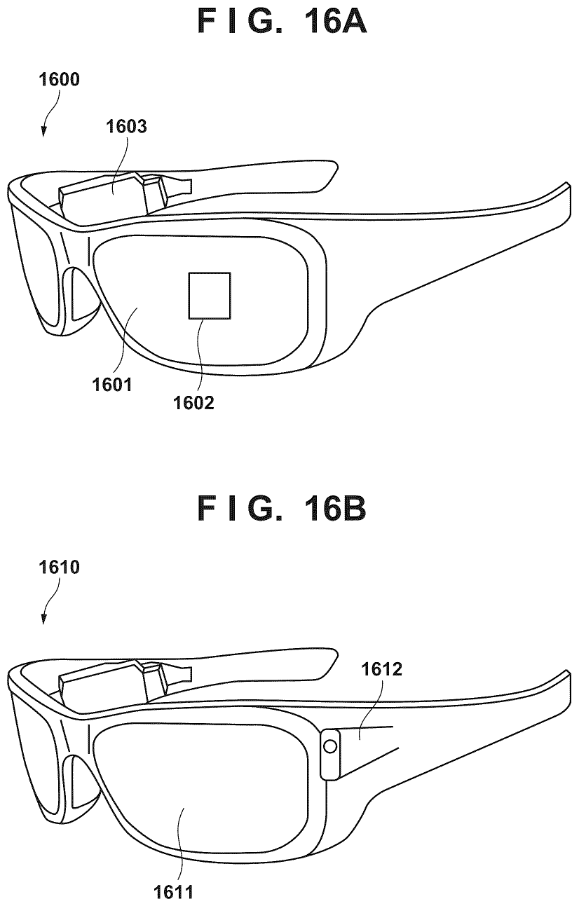

Further application examples of the light emitting device 100 according to this embodiment will be described with reference to FIGS. 16A and 16B. The light emitting device 100 can be applied to a system that can be worn as a wearable device such as smartglasses, a Head Mounted Display (HMD), or a smart contact lens. An image capturing display device used for such application examples includes an image capturing device capable of photoelectrically converting visible light and a light emitting device capable of emitting visible light.

Glasses 1600 (smartglasses) according to one application example will be described with reference to FIG. 16A. An image capturing device 1602 such as a CMOS sensor or an SPAD is provided on the surface side of a lens 1601 of the glasses 1600. In addition, the light emitting device 100 according to this embodiment is provided on the back surface side of the lens 1601.

The glasses 1600 further include a control device 1603. The control device 1603 functions as a power supply that supplies electric power to the image capturing device 1602 and the light emitting device 100 according to each embodiment. In addition, the control device 1603 controls the operations of the image capturing device 1602 and the light emitting device 100. An optical system configured to condense light to the image capturing device 1602 is formed on the lens 1601.

Glasses 1610 (smartglasses) according to one application example will be described with reference to FIG. 16B. The glasses 1610 include a control device 1612, and an image capturing device corresponding to the image capturing device 1602 and the light emitting device 100 are mounted on the control device 1612. The image capturing device in the control device 1612 and an optical system configured to project light emitted from the light emitting device 100 are formed in a lens 1611, and an image is projected to the lens 1611. The control device 1612 functions as a power supply that supplies electric power to the image capturing device and the light emitting device 100, and controls the operations of the image capturing device and the light emitting device 100. The control device 1612 may include a line-of-sight detection unit that detects the line of sight of a wearer. The detection of a line of sight may be done using infrared rays. An infrared ray emitting unit emits infrared rays to an eyeball of the user who is gazing at a displayed image. An image capturing unit including a light receiving element detects reflected light of the emitted infrared rays from the eyeball, thereby obtaining a captured image of the eyeball. A reduction unit for reducing light from the infrared ray emitting unit to the display unit in a planar view is provided, thereby reducing deterioration of image quality.

The line of sight of the user to the displayed image is detected from the captured image of the eyeball obtained by capturing the infrared rays. An arbitrary known method can be applied to the line-of-sight detection using the captured image of the eyeball. As an example, a line-of-sight detection method based on a Purkinje image obtained by reflection of irradiation light by a cornea can be used.

More specifically, line-of-sight detection processing based on pupil center corneal reflection is performed. Using pupil center corneal reflection, a line-of-sight vector representing the direction (rotation angle) of the eyeball is calculated based on the image of the pupil and the Purkinje image included in the captured image of the eyeball, thereby detecting the line-of-sight of the user.

The light emitting device 100 according to the embodiment of the present disclosure can include an image capturing device including a light receiving element, and control a displayed image based on the line-of-sight information of the user from the image capturing device.

More specifically, the light emitting device 100 decides a first visual field region at which the user is gazing and a second visual field region other than the first visual field region based on the line-of-sight information. The first visual field region and the second visual field region may be decided by the control device of the light emitting device 100, or those decided by an external control device may be received. In the display region of the light emitting device 100, the display resolution of the first visual field region may be controlled to be higher than the display resolution of the second visual field region. That is, the resolution of the second visual field region may be lower than that of the first visual field region.

In addition, the display region includes a first display region and a second display region different from the first display region, and a region of higher priority is decided from the first display region and the second display region based on line-of-sight information. The first display region and the second display region may be decided by the control device of the light emitting device 100, or those decided by an external control device may be received. The resolution of the region of higher priority may be controlled to be higher than the resolution of the region other than the region of higher priority. That is, the resolution of the region of relatively low priority may be low.

Note that AI may be used to decide the first visual field region or the region of higher priority. The AI may be a model configured to estimate the angle of the line of sight and the distance to a target ahead the line of sight from the image of the eyeball using the image of the eyeball and the direction of actual viewing of the eyeball in the image as supervised data. The AI program may be held by the light emitting device 100, the image capturing device, or an external device. If the external device holds the AI program, it is transmitted to the light emitting device 100 via communication.

When performing display control based on line-of-sight detection, smartglasses further including an image capturing device configured to capture the outside can be applied. The smartglasses can display captured outside information in real time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-010290, filed Jan. 26, 2024, which is hereby incorporated by reference herein in its entirety.

What is claimed is:

1. A light emitting device comprising:
a plurality of pixel circuits each including a light emitting element configured to emit light with a brightness corresponding to a pixel signal;
a driving circuit configured to select, from the plurality of pixel circuits, a pixel circuit to write the pixel signal; and
a plurality of power supply lines configured to supply power supply voltages to the plurality of pixel circuits, wherein
the plurality of power supply lines include a power supply line extending in a first direction in a portion overlapping a part of the plurality of pixel circuits,
a number of pixel circuits to be selected by the driving circuit at a first timing from two or more pixel circuits, of the plurality of pixel circuits, arranged along the first direction is not more than two, and
a number of pixel circuits to be selected by the driving circuit at a second timing from two or more pixel circuits, of the plurality of pixel circuits, arranged along a second direction orthogonal to the first direction is not more than two.

2. The device according to claim 1, wherein the plurality of power supply lines further include a power supply line extending in the second direction in a portion overlapping a part of the plurality of pixel circuits.

3. The device according to claim 1, wherein
the number of pixel circuits to be selected by the driving circuit at the first timing from the two or more pixel circuits, of the plurality of pixel circuits, arranged along the first direction is not more than one, and
the number of pixel circuits to be selected by the driving circuit at the second timing from the two or more pixel circuits, of the plurality of pixel circuits, arranged along the second direction is not more than one.

4. The device according to claim 1, further comprising a plurality of scanning lines configured to supply selection signals to the plurality of pixel circuits from the driving circuit,
wherein at least one of the plurality of scanning lines includes a portion obliquely intersecting both the first direction and the second direction.

5. The device according to claim 4, wherein the driving circuit supplies a selection signal with a higher driving force to a longer scanning line.

6. The device according to claim 1, wherein
the plurality of pixel circuits are arranged in rows and columns, and
each of the rows is parallel to the first direction or each of the columns is parallel to the first direction.

7. The device according to claim 1, wherein
the plurality of pixel circuits are arranged in rows and columns, and
each of the rows and each of the columns obliquely intersect the first direction.

8. A display device comprising a light emitting device according to claim 1, and an active element connected to the light emitting device.

9. A photoelectric conversion device comprising an optical unit including a plurality of lenses, an image sensor configured to receive light having passed through the optical unit, and a display unit configured to display an image,
wherein the display unit displays an image captured by the image sensor, and includes a light emitting device according to claim 1.

10. An electronic apparatus comprising a housing provided with a display unit, and a communication unit provided in the housing and configured to perform external communication,
wherein the display unit includes a light emitting device according to claim 1.

11. An illumination device comprising a light source, and at least one of a light diffusing unit and an optical film,
wherein the light source includes a light emitting device according to claim 1.

12. A moving body comprising a main body, and a lighting appliance provided in the main body,
wherein the lighting appliance includes a light emitting device according to claim 1.
